(19) United States
(12) Patent Application Publication
(10) Pub. No.: US 2024/0196186 A1
(43) Pub. Date: Jun. 13, 2024

(54) COMMUNICATION CONTROL METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/413,718

(22) Filed: Jan. 16, 2024

Related U.S. Application Data
(63) Continuation of application No. PCT/JP2022/027460, filed on Jul. 12, 2022.

(30) Foreign Application Priority Data
Jul. 16, 2021 (JP) 2021-118338

(51) Int. Cl. H04W 8/00; H04W 40/22; H04W 76/14

(52) U.S. Cl. CPC H04W 8/005; H04W 40/22; H04W 76/14

(57) ABSTRACT

A communication control method includes acquiring, by a first user equipment, second identification information to identify a second user equipment, and acquiring, by the second user equipment, first identification information to identify the first user equipment, the first user equipment and the second user equipment being in a state of discovery with each other. The communication control method further includes transmitting, by the first user equipment, the second identification information to a communication apparatus, and transmitting, by the second user equipment, the first identification information to the communication apparatus. The communication control method further includes configuring, by the communication apparatus, a first data radio bearer to the first user equipment in response to receiving the second identification information, and configuring, by the communication apparatus, a second data radio bearer to the second user equipment in response to receiving the first identification information.

### RELATED APPLICATIONS

The present application is a continuation based on PCT Application No. PCT/JP2022/027460, filed on Jul. 12, 2022, which claims the benefit of Japanese Patent Application No. 2021-118338 filed on Jul. 16, 2021. The content of which is incorporated by reference herein in their entirety.

### TECHNICAL FIELD

The present disclosure relates to a communication control method used in a cellular communication system.

### BACKGROUND OF INVENTION

In the Third Generation Partnership Project (3GPP), which is a standardization project for cellular communication systems, various routing techniques for user data are under study. For example, in the fifth generation (5G) cellular communication system, a functional block called User Plane Function (UPF) performs routing of user data.

### CITATION LIST

### Non-Patent Literature

Non-Patent Document 1: 3GPP TS 38.300 V16.6.0 (2021-06)

### SUMMARY

A communication control method according to a first aspect includes acquiring, by a first user equipment, second identification information to identify a second user equipment, and acquiring, by the second user equipment, first identification information to identify the first user equipment, the first user equipment and the second user equipment being in a state of discovery with each other. The communication control method further includes transmitting, by the first user equipment, the second identification information to a communication apparatus, and transmitting, by the second user equipment, the first identification information to the communication apparatus. The communication control method further includes configuring, by the communication apparatus, a first data radio bearer to the first user equipment in response to receiving the second identification information, and configuring, by the communication apparatus, a second data radio bearer to the second user equipment in response to receiving the first identification information. The communication control method further includes transferring, by the communication apparatus, first data received from the first user equipment by using the first data radio bearer to the second user equipment by using the second data radio bearer without transferring the first data to a core network.

A communication control method according to a second aspect includes transmitting, by a first user equipment to a base station, a discovery identifier of a second user equipment acquired when the first user equipment discovers the second user equipment. The communication control method further includes making an inquiry, by the base station, to a user equipment subordinate to the base station whether the user equipment includes the discovery identifier, in response to receiving the discovery identifier. The communication control method further includes responding, by the second user equipment, to the inquiry. The communication control method further includes, by the base station, configuring a first data radio bearer for the first user equipment and configuring a second data radio bearer for the second user equipment, in response to the response. The communication control method further includes transferring, by the base station, first data received from the first user equipment by using the first data radio bearer to the second user equipment by using the second data radio bearer without transferring the first data to a core network.

A communication control method according to a third aspect includes transferring, by a base station, data received from the first user equipment by using a data radio bearer to a second user equipment without transferring the data to a core network. The communication control method includes transmitting, by the base station, a data amount of the data to the core network.

### BRIEF DESCRIPTION OF THE DRAWINGS

FIG. 1 is a diagram illustrating a configuration example of a cellular communication system according to an embodiment.

FIG. 2 is a diagram illustrating a configuration example of a user equipment (UE) according to an embodiment.

FIG. 3 is a diagram illustrating a configuration example of a gNB (base station) according to an embodiment.

FIG. 4 is a diagram illustrating a configuration example of a protocol stack for a user plane according to an embodiment.

FIG. 5 is a diagram illustrating a configuration example of a protocol stack for a control plane according to an embodiment.

FIGS. 6A and 6B are diagrams illustrating examples of routing according to a first embodiment.

FIG. 7 is a diagram illustrating an example of local rerouting according to a first embodiment.

FIG. 8 is a diagram illustrating an example of a protocol stack according to the first embodiment.

FIG. 9 is a diagram illustrating an operation example according to the first embodiment.

FIG. 10 is a diagram illustrating an operation example according to the second embodiment.

FIG. 11 is a diagram illustrating an operation example according to a third embodiment.

FIG. 12 is a diagram illustrating an operation example according to a fourth embodiment.

### DESCRIPTION OF EMBODIMENTS

The present disclosure provides a communication control method in which routing is appropriately performed.

A cellular communication system in an embodiment is described with reference to the drawings. In the description of the drawings, the same or similar parts are denoted by the same or similar reference signs.

### Cellular Communication System

First, a configuration of a cellular communication system according to an embodiment is described. Although the cellular communication system according to an embodiment is a 5G system of 3GPP, LTE may be at least partially applied to the cellular communication system. A future cellular communication system such as the 6G may be applied to the cellular communication system 1.

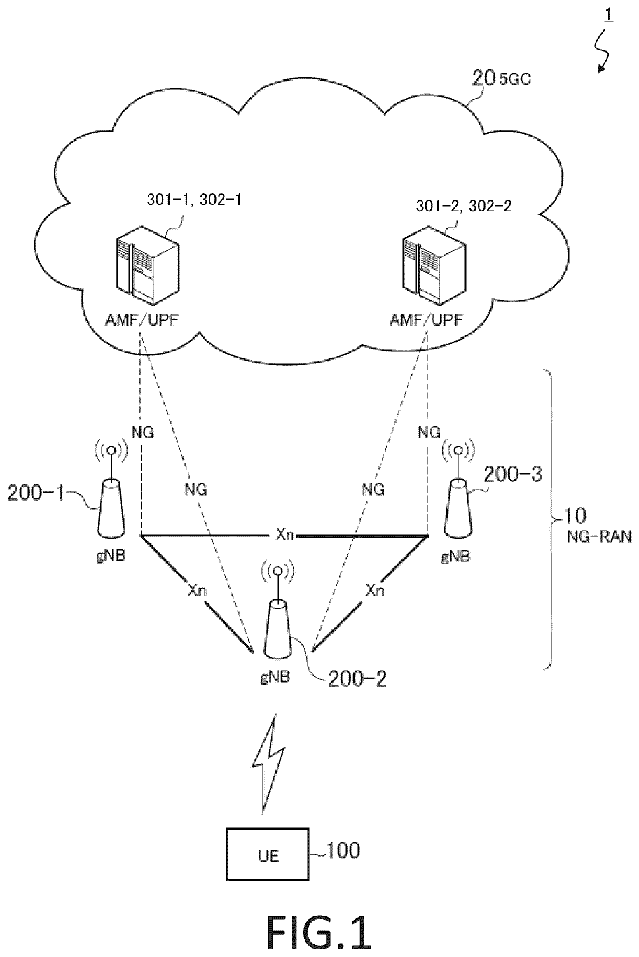

FIG. 1 is a diagram illustrating a configuration example of the cellular communication system 1 according to an embodiment.

As illustrated in FIG. 1, a cellular communication system 1 includes a User Equipment (UE) 100, a 5G radio access network (Next Generation Radio Access Network (NG-RAN)) 10, and a 5G Core Network (5GC) 20.

The UE 100 is a mobile apparatus. The UE 100 may be any apparatus as long as utilized by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), or a flying object or an apparatus provided on a flying object (Aerial UE).

The NG-RAN 10 includes base stations (referred to as “gNBs” in the 5G system) 200. The gNBs 200 may also be referred to as NG-RAN nodes. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 includes a radio resource management (RRM) function, a function of routing user data (hereinafter simply referred to as “data”), or a measurement control function for mobility control and scheduling. The “cell” is used as a term representing a minimum unit of a wireless communication area. The “cell” is also used as a term representing a function or a resource for performing wireless communication with the UE 100. One cell belongs to one carrier frequency.

Note that the gNB may be connected to an Evolved Packet Core (EPC) which is a core network of LTE, or a base station of LTE may be connected to the 5GC 20. The base station of LTE and the gNB may be connected via the inter-base station interface.

The 5GC 20 includes an Access and Mobility Management Function (AMF) 301 (301-1 and 301-2) and a User Plane Function (UPF) 302 (302-1 and 302-2). The AMF 301 performs various types of mobility controls and the like for the UE 100. The AMF 301 communicates with the UE 100 by using Non-Access Stratum (NAS) signaling, and thereby manages information of an area in which the UE 100 exists. The UPF 302 controls data transfer. The AMF 301 and the UPF 302 are connected to the gNB 200 via an NG interface which is an interface between the base station and the core network. The AMF 301 and the UPF 302 are examples of core network apparatuses connected to the 5GC (core network) 20.

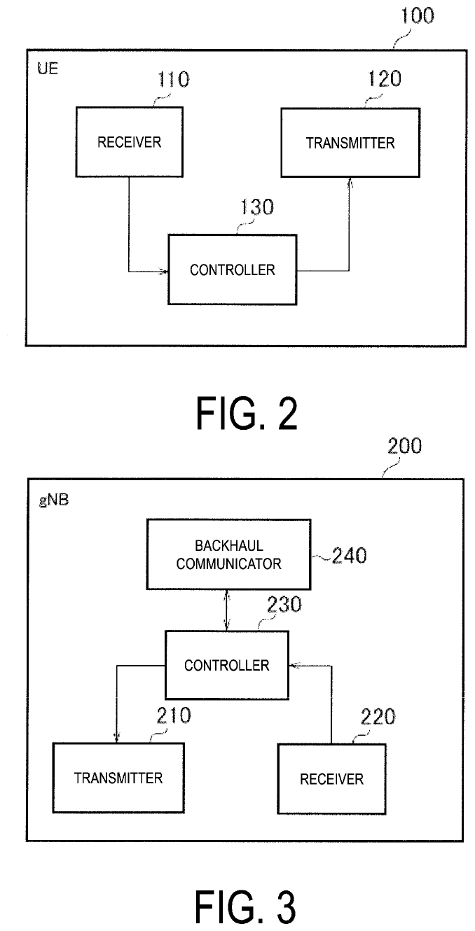

FIG. 2 is a diagram illustrating a configuration example of the user equipment (UE) 100 according to an embodiment.

As illustrated in FIG. 2, the UE 100 includes a receiver 110, a transmitter 120, and a controller 130.

The receiver 110 performs various types of reception under control of the controller 130. The receiver 110 includes an antenna and a reception device. The reception device converts (down-converts) a radio signal received through the antenna into a baseband signal (a received signal) and outputs the resulting signal to the controller 130.

The transmitter 120 performs various types of transmission under control of the controller 130. The transmitter 120 includes an antenna and a transmission device. The transmission device converts (up-converts) a baseband signal output by the controller 130 (a transmission signal) into a radio signal and transmits the resulting signal through the antenna.

The controller 130 performs various types of control in the UE 100. The controller 130 includes at least one processor and at least one memory electrically connected to the processor. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. The controller 130 may execute various types of processing to be performed by the UE 100 in each embodiment described below.

FIG. 3 is a diagram illustrating a configuration example of the gNB 200 (base station) according to an embodiment.

As illustrated in FIG. 3, the gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts (up-converts) a baseband signal output by the controller 230 (a transmission signal) into a radio signal and transmits the resulting signal through the antenna.

The receiver 220 performs various types of reception under control of the controller 230. The receiver 220 includes an antenna and a reception device. The reception device converts (down-converts) a radio signal received through the antenna into a baseband signal (a received signal) and outputs the resulting signal to the controller 230.

The controller 230 performs various types of controls for the gNB 200. The controller 230 includes at least one processor and at least one memory electrically connected to the processor. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The controller 230 may execute various types of processing to be performed by the gNB 200 in each embodiment described below.

The backhaul communicator 240 is connected to a neighboring base station via the inter-base station interface. The backhaul communicator 240 is connected to the AMF 301 and/or the UPF 302 via the interface between the base station and the core network. Note that the gNB may include a Central Unit (CU) and a Distributed Unit (DU), and both units may be connected to each other via an F1 interface.

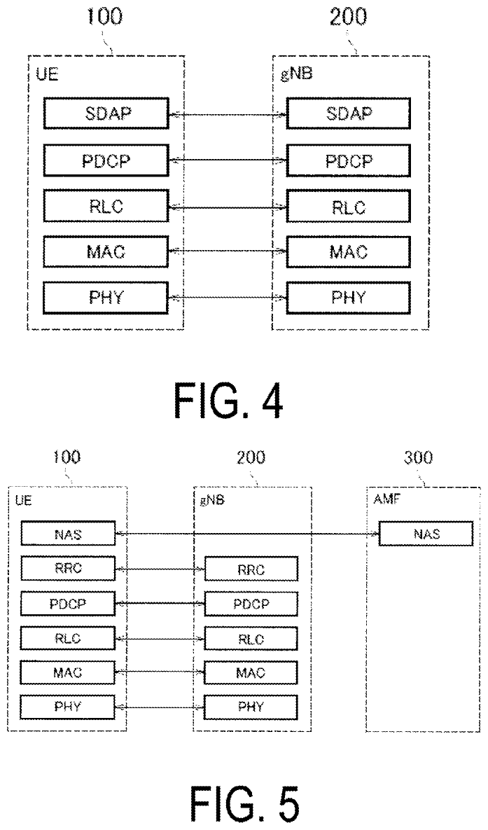

FIG. 4 is a diagram illustrating a configuration example of a radio interface protocol stack for a user plane according to an embodiment.

As illustrated in FIG. 4, a radio interface protocol for the user plane to hand data includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel.

The MAC layer performs preferential control of data, retransmission processing using a hybrid ARQ (HARQ), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, modulation and coding schemes (MCSs)) in the uplink and the downlink, and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression and decompression, and encryption and decryption. Data and control information are transmitted between the PDCP layer of the UE 100 and the PDCP layer of the gNB 200 via a radio bearer.

The SDAP layer maps a QoS flow that is a unit in which the core network performs QoS control onto a radio bearer that is a unit in which the access stratum (AS) performs QoS control. Note that, when the RAN is connected to the EPC, the SDAP need not be provided.

FIG. 5 is a diagram illustrating a configuration example of a radio interface protocol stack for a control plane according to an embodiment.

As illustrated in FIG. 5, the radio interface protocol stack for the control plane to handle signaling (control signals) includes a Radio Resource Control (RRC) layer and a NAS layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection between the RRC of the UE 100 and the RRC of the gNB 200 (RRC connection) exists, the UE 100 is in an RRC connected state. When a connection between the RRC of the UE 100 and the RRC of the gNB 200 (RRC connection) does not exist, the UE 100 is in an RRC idle state. When the RRC connection is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of the AMF 301.

Note that the UE 100 includes an application layer other than the protocol of the radio interface.

### First Embodiment

### A First Embodiment is Described

The first embodiment is an embodiment relating to routing. Here, an example of the routing according to the first embodiment is described.

### Example of Routing

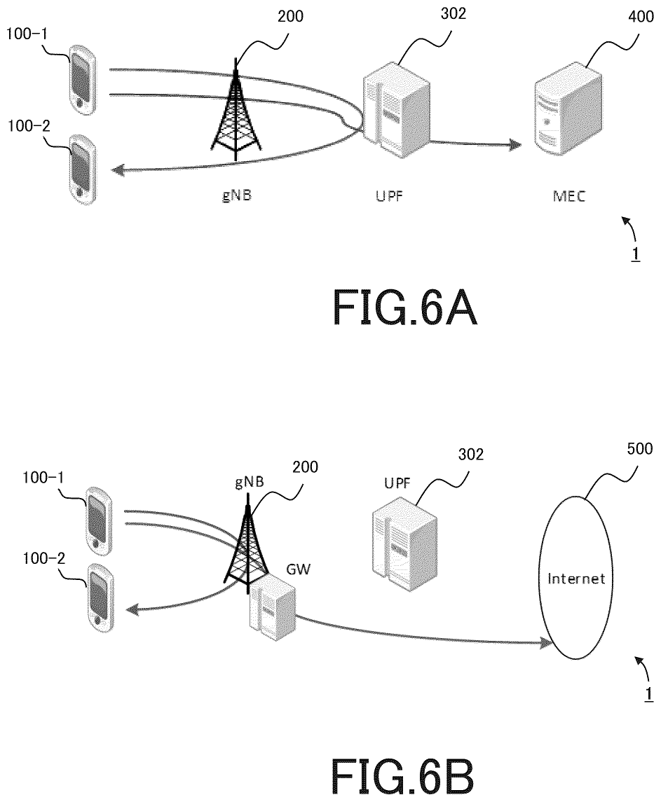

FIG. 6A is a diagram illustrating an example of the routing according to the first embodiment. The routing is, for example, to select a path so that data (packet) transmitted from a transmission source can be correctly transmitted to a destination (or a transmission destination). In general, the routing is performed in an Internet Protocol (IP) layer.

In the 5G system, the UPF 302 may perform processing on the IP layer. Therefore, as illustrated in FIG. 6A, the UPF 302 performs the routing. Since the UPF 302 performs the routing, FIG. 6A illustrates an example in which a Mobile Edge Computing (MEC) server 400 is connected to the UPF 302.

FIG. 6B is a diagram illustrating an example of the routing according to the first embodiment. As illustrated in FIG. 6B, in the cellular communication system 1, a technique has been proposed for connecting to the Internet without involving the core network. Such a technique may be referred to as local breakout. The local breakout is also an example of the routing. The example of FIG. 6B illustrates an example in which the routing is performed by the GW connected to the gNB 200.

In addition, there is a locally routed mode in device to device (D2D) communication in which a plurality of proximate UEs 100 directly perform data communication without involving a core network. The locally routed mode is a mode in which a data path passes through an evolved Node B (eNB), different from a direct communication mode in which a data path does not pass through the eNB.

The examples illustrated in FIGS. 6A and 6B mainly illustrate examples in which routing is performed in a layer 3 (IP layer).

However, in 5G system communication, as illustrated in FIG. 6A, even when a UE 100-1 and a UE 100-2 exist within a coverage of the same gNB 200, data transmitted from the UE 100-1 is made to reach the core network (UPF 302) and be looped back along the same path.

In such a case, if the data can be routed without involving the core network, it is possible to reduce a traffic amount in the core network or reduce delay occurring in the communication in the core network. Such routing not via the core network may be referred to as local routing.

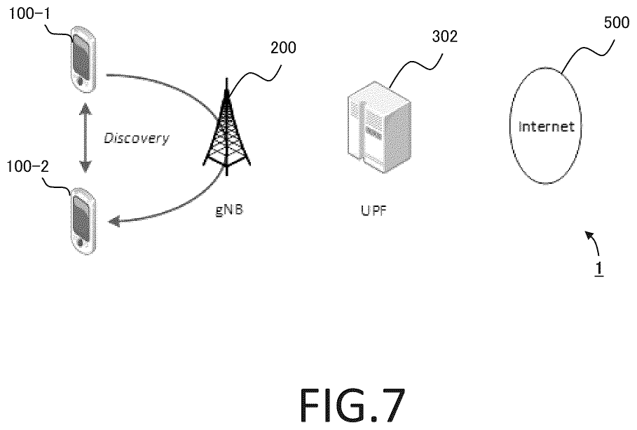

FIG. 7 is a diagram illustrating an example of local routing according to the first embodiment. As illustrate in FIG. 7, the gNB 200 may perform local routing. However, in the gNB 200, processing for a layer 2 (SDAP layer (or PDCP layer)) can be performed, but processing for the layer 3 (IP layer) cannot be performed.

Therefore, how to perform the local routing by the layer 2 in the gNB 200 is a problem.

As such, in the first embodiment, when UE 100-1 and UE 100-2 are in a state of discovery, the UE 100-1 transmits Radio Access Network (RAN) identification information to the gNB 200. Then, in response to receiving the RAN identification information, the gNB 200 configures a data radio bearer (DRB) for local routing for the UE 100-1. The gNB 200 transfers data transmitted from the UE 100-1 using the DRB to the UE 100-2 without transferring the data to the core network.

To be specific, first, a first user equipment (for example, UE 100-1) and a second user equipment (for example, UE 100-2) are in a state of discovery with each other and the first user equipment acquires second identification information to identify the second user equipment, and the second user equipment acquires first identification information to identify the first user equipment. Second, the first user equipment transmits the second identification information to a communication apparatus (e.g., gNB 200), and the second user equipment transmits the first identification information to the communication apparatus. Third, the communication apparatus, in response to receiving the second identification information, configures a first data radio bearer for the first user equipment, and configures, in response to receiving the first identification information, a second data radio bearer for the second user equipment. Fourth, the communication apparatus transfers first data received from the first user equipment by using the first data radio bearer to the second user equipment by using the second data radio bearer without transferring the first data to the core network.

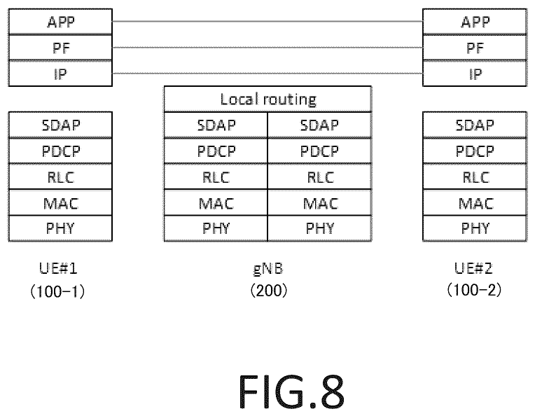

FIG. 8 is a diagram illustrating an example of a protocol stack according to the first embodiment. The SDAP layer or PDCP layer (layer 2) is a layer capable of performing processing related to a data radio bearer (DRB). As illustrate in FIG. 8, the gNB 200 can handle the SDAP layer (or PDCP layer). The gNB 200 can configure a DRB for local routing for the UE 100-1 (and the UE 100-2), and thereby transfer data transmitted from the UE 100-1 using the DRB to the UE 100-2 without transferring the data to the core network. Therefore, the gNB 200 can perform routing by the layer 2. Note that an SDAP sublayer may not be provided in the protocol stack. In this case, a Local routing layer is located above a PDCP sublayer.

### Operation Example of First Embodiment

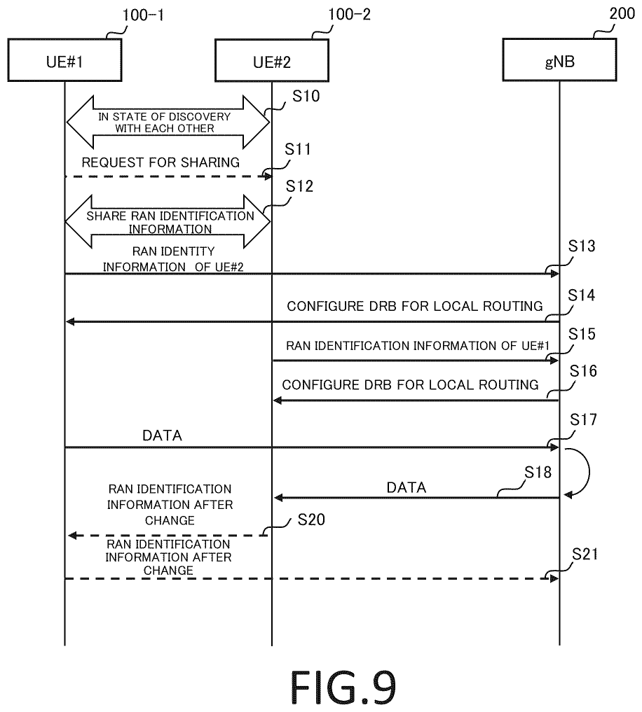

FIG. 9 is a diagram illustrating an operation example according to the first embodiment. Similar to the configuration example of the cellular communication system 1 illustrated in FIG. 7, the operation example illustrated in FIG. 9 illustrates an example of the local routing in which the gNB 200 transfers data transmitted from the UE 100-1 to the UE 100-2 without transferring the data to the UPF 302.

Note that although the UE 100-1 is connected to the gNB 200, the UE 100-2 may not be connected to the gNB 200. When the UE 100-2 is not connected to the gNB 200, the UE 100-2 is assumed to be connected to another gNB.

Hereinafter, a UE #1 may be referred to as the UE 100-1 and a UE #2 may be referred to as the UE 100-2.

As illustrated in FIG. 9, in step S10, the UE 100-1 and the UE 100-2 are in a state of discovery with each other. The UE 100-1 may discover the UE 100-2 by using a discovery function and the UE 100-2 may also discover the UE 100-1 by using the discovery function so that they are in the state of discovery with each other. The discovery function may be a function using Direct Discovery of Proximity-based services (Prose) communication. The discovery function may be a function using Open Connectivity Foundation.

In step S11, the UE 100-1 may request the UE 100-2 to share the RAN identification information. For example, the UE 100-1 may transmit the request to the UE 100-2 by using

### Prose Direct Communication.

Here, the RAN identification information is identification information of the UE 100 on the RAN.

First, the RAN identification information includes a Public Land Mobile Network ID (PLMN ID), a gNB ID, a cell ID, and a Cell radio-Radio Network Temporary Identifier (C-RNTI). These four pieces of identification information being included in the RAN identification information makes it possible to identify the UE 100 in a specific cell of a specific base station of a specific operator.

Second, the RAN identification information may be International Mobile Subscriber Identity (IMSI) or 5g-S-Temporary Mobile Subscriber Identity (TMSI).

Third, the RAN identification information may be a Proximity-based services ID (Prose ID) of sidelink communication. Examples of the Prose ID include a Destination Layer-2 ID and/or a Source Layer-2 ID, for example.

Fourth, the RAN identification information may include an IP address or an ID of an application layer (including a platform layer).

In step S12, the UE 100-2 shares the RAN identification information with the UE 100-1. For example, the UE 100-1 may acquire the RAN identification information of the UE 100-2 from the UE 100-2 by using the Prose Direct Communication. The UE 100-2 may also acquire the RAN identification information of the UE 100-1 from the UE 100-1 by using the Prose Direct Communication. The UE 100-1 and the UE 100-2 share the RAN identification information by acquiring the RAN identification information of the other party from each other. In step S13, the UE 100-1 transmits the RAN identification information of the UE 100-2 to the gNB 200. The transmission of the RAN identification information may function as a request for local routing.

In step S14, the gNB 200, in response to receiving the RAN identification information, configures a DRB for local routing for the UE 100-1. The gNB 200 may transmit an RRC message including radio bearer configuration information (radioBearerConfig) and the like to the UE 100-1, and thereby configure the DRB for local routing.

The DRB is a DRB the UE 100-1 uses in transmitting data addressed to the UE 100-2. The DRB may be a DRB the UE 100-1 uses in receiving data transmitted from the UE 100-2. The UE 100-1 can map the data addressed to the UE 100-2 to the DRB to transmit the data to the UE 100-2. Therefore, the DRB may be associated with the RAN identification information of the UE 100-2 as restriction information.

Note that when the UE 100-2 is subordinate to another gNB, the gNB 200 may establish a data forwarding tunnel session with the other.

In step S15, the UE 100-2 transmits the RAN identification information of the UE 100-1 to the gNB 200 as in step S13.

In step S16, the gNB 200, in response to receiving the RAN identification information, configures a DRB for local routing for the UE 100-2, as in step S14. In this case, the gNB 200 associates the DRB configured for the UE 100-1 with the DRB configured for the UE 100-2. By doing so, the gNB 200 can also route a communication path between the UE 100-1 and the gNB 200 and a communication path between the UE 100-2 and the gNB 200.

In step S17, the UE 100-1 transmits data addressed to the UE 100-2. The UE 100-1 can map the data to the DRB for local routing configured in step S14 to transmit the data on the DRB for local routing.

In step S18, the gNB 200 performs local routing on the data received from the UE 100-1. The gNB 200 transfers the data to the UE 100-2 without transferring the data to the core network. For example, the local routing may be performed in the following manner.

The gNB 200 has associated the DRB for local routing for the UE 100-2 (in step S16) with the DRB for local routing configured for the UE 100-1 (in step S14). Therefore, the gNB 200 can map the data transmitted by using the DRB for local routing configured for the UE 100-1 to the DRB for local routing configured for the UE 100-2 to transfer the data to the UE 100-2.

Note that the example in FIG. 9 illustrates an example in which local routing is performed on the data transmitted from UE 100-1 to transfer the data to the UE 100-2. For example, the gNB 200 configures the DRB for local routing for the UE 100-2 (steps S15 and S16). This makes it possible to not only transfer data transmitted from the UE 100-1 to the UE 100-2, but also transfer data transmitted from the UE 100-2 to the UE 100-1, for example. That is, the UE 100-1 and the UE 100-2 can perform data transmission and reception with each other via the gNB 200 without involving the core network.

In step S20, when a change of the RAN identification information of the UE 100-2 itself occurs, the UE 100-2 may transmit new RAN identification information after the change to the UE 100-1.

Here, the change of the RAN identification information corresponds to, for example, a change of the cell ID of the connection destination caused by the UE 100-2 moving. In step S20, the UE 100-2, which transmits the new RAN identification information to UE 100-1, may transmit the new RAN identification information to a move destination gNB to which the UE 100-2 moved. In this case, the UE 100-2 may transmit information indicating that the DRB for local routing has been given to the move destination gNB. When the new RAN identification information is transmitted to the move destination gNB by the UE 100-2, the move destination gNB may transmit the new RAN identification information to the former gNB 200.

In step S21, the UE 100-1 may transmit the new RAN identification information of the UE 100-2 to the gNB 200.

### Variation of First Embodiment

### A Variation of the First Embodiment is Described

The first embodiment describes that the UE 100-1 is in the state of discovery in which the UE 100-1 has discovered the UE 100-2 (step S10). For example, although the UE 100-1 has discovered the UE 100-2, the UE 100-1 may not discover the UE 100-2 because the UE 100-2 moves. In this case, the UE 100-1 may transmit information indicating that the UE 100-2 cannot be discovered to the gNB 200. The information may be a request to remove the configured DRB for local routing from the gNB 200. The gNB 200, in response to receiving the information, removes the DRB for local routing configured for the UE 100-1 and also removes the DRB for local routing configured for the UE 100-2 if possible.

The first embodiment also describes that the gNB 200 performs local routing. A UE 100-3 may perform the local routing instead of the gNB 200. In this case, the UE 100-3 functions as a relay UE between the two UEs 100-1 and 100-2, and the gNB 200. The relay UE 100-3, upon receiving the RAN identification information of the UE 100-2 from the UE 100-1, configures a DRB for local routing for the UE 100-1, as the gNB 200 in the first embodiment. The relay UE 100-3, upon receiving the RAN identification information of the UE 100-1 from the UE 100-2, configures a DRB for local routing for the UE 100-2. Then, the relay UE 100-3 can use these DRBs to respectively transfer data transmitted from the UE 100-1 to the UE 100-2 and data transmitted from the UE 100-1 to the UE 100-2 without transferring the data to the gNB 200. In this case, the DRB may be a Side Link DRB (SL-DRB). As the RAN identification information, the Destination Layer-2 ID and/or the Source Layer-2 ID may be used.

### Second Embodiment

### A Second Embodiment is Described

The first embodiment describes the example in which the RAN identification information is used. The second embodiment describes an example in which a discovery identifier is used instead of the RAN identification information.

To be specific, first, the first user equipment (for example, UE 100-1) transmits a discovery identifier of the second user equipment (for example, UE 100-2) to the base station (for example, gNB 200), the discovery identifier of the second user equipment being acquired when the first user equipment discovers the second user equipment. Second, the base station, in response to receiving the discovery identifier, makes an inquiry to the user equipment subordinate to the base station whether the user equipment includes the discovery identifier. Third, the second user equipment responds to the inquiry. Fourth, the base station, in response to the response, configures the first data radio bearer for the first user equipment and configures the second data radio bearer for the second user equipment. Fifth, the base station transfers the data received from the first user equipment by using the first data radio bearer to the second user equipment by using the second data radio bearer without transferring the data to the core network.

In this way, the gNB 200 finds by itself the UE 100-2 discovered by the UE 100-1 by using the discovery identifier, and thereby configures a DRB for local routing for the UE 100-1 to perform the local routing. Thus, the gNB 200 can appropriately perform the local routing by the layer 2 also in the second embodiment, as in the first embodiment.

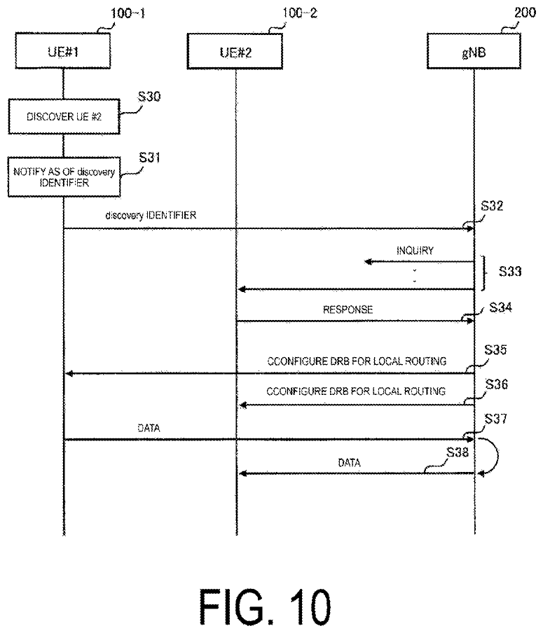

FIG. 10 is a diagram illustrating an operation example according to the second embodiment.

As illustrated in FIG. 10, in step S30, the UE 100-1 discovers the UE 100-2 by using the discovery function. The discovery function may be a function using the Direct Discovery of ProSe communication as in the first embodiment. The discovery function may be a function using the higher layer (e.g., Open Connectivity Foundation). The UE 100-1 may determine to communicate with the UE 100-2 instead of or together with the discovery.

In step S31, the UE 100-1 notifies the access stratum (AS) of the discovery identifier. For example, the higher layer (e.g., application layer) of the UE 100-1 performs the discovery function to acquires the discovery identifier of the UE 100-2.

Here, the discovery identifier, when the UE 100-1 discovers the other party UE 100-2 by performing the discovery function, functions as an identifier for identifying the UE. The discovery identifier of the UE 100-2 may be an identifier for the UE 100-1 to identify the UE to which data is to be transmitted. The discovery identifier of the UE 100-1 may be also an identifier to identify the UE from which the data is transmitted. The UE 100-1 may acquire the discovery identifier of the UE 100-2 from the UE 100-2 by way of the discovery of the UE 100-2. The UE 100-2 may also acquire the discovery identifier of the UE 100-2 from the UE 100-1 by way of the discovery.

In step S32, the UE 100-1 transmits the discovery identifier to the gNB 200. The transmitted discovery identifier includes the discovery identifier of the UE 100-2. The transmitted discovery identifier may include the discovery identifier of the UE 100-1.

In step S33, the gNB 200, in response receiving the discovery identifier, makes an inquiry to the subordinate UE whether the UE includes the discovery identifier of the UE 100-2. In this case, the gNB 200 may request another gNB to makes an inquiry whether the other gNB includes the discovery identifier of the UE 100-2. The gNB 200 may broadcast a system information block (SIB) message including the discovery identifier of the UE 100-2 to make the inquiry.

In step S34, the UE 100-2 responds to the inquiry. The UE 100-2, because of being subordinate to the gNB 200, responds to the inquiry from the gNB 200. For example, the UE 100-2 may transmit an RRC message as a response message to the gNB 200 to make the response. When the UE 100-2 is subordinate to another gNB, the other gNB may transmit, to the gNB 200, information indicating that the UE 100-2 exists in the other gNB.

In step S35, the gNB 200 configures a DRB for local routing for the UE 100-1. The DRB may be used when the UE 100-1 transmits data addressed to the UE 100-2, or may be used when the UE 100-1 receives data addressed to the UE 100-1 transmitted from the UE 100-2, like the DRB in the first embodiment (step S14 in FIG. 10). The UE 100-1 maps the data addressed to the UE 100-2 to the DRB to perform the data transmission. The DRB may be associated with the discovery identifier of the UE 100-2 as the restriction information.

In step S36, the gNB 200 configures a DRB for local routing for the UE 100-2. In this case, the gNB 200 associates the DRB for local routing configured for the UE 100-1 with the DRB for local routing configured for the UE 100-2 to route as a communication path, as in the first embodiment.

In step S37, the UE 100-1 transmits the data addressed to the UE 100-2 to the gNB 200 by using the DRB for local routing.

In step S38, the gNB 200 receives the data addressed to the UE 100-2 transmitted by using the DRB, and transfers the received data to the UE 100-2 without transferring the data to the core network. The gNB 200 transfers the received data to the UE 100-2 by using the DRB for local routing configured for the UE 100-1 (step S35) and the DRB for local routing configured for the UE 100-2 (step S36). In this case, the gNB 200 can transfer the data transmitted from the UE 100-1 to the UE 100-2 because the DRB configured for the UE 100-1 (step S35) is associated with the DRB configured for the UE 100-2 (step S36).

Note that the gNB 200 configuring the DRB for local routing for the UE 100-2 (step S36) may enable only the data transfer from the UE 100-1 to the UE 100-2 but also data transfer from the UE 100-2 to the UE 100-1, as in the first embodiment.

### Third Embodiment

### A Third Embodiment is Described

The third embodiment is an example in which the AMF 301 notifies the gNB 200 that the UE 100-1 and the UE 100-2 are a pair for a Peer to Peer (P2P) communication. Here, the P2P communication means that the UE 100-1 and the UE 100-2 communicate with each other via the gNB 200 without involving the core network. In the third embodiment, P2P communication and local routing may be used without being distinguished from each other.

To be specific, first, the core network apparatus (for example, AMF 301) connected to the core network transmits, to the base station (for example, gNB 200), pairing information indicating that the first user equipment (for example, UE 100-1) and the second user equipment (for example, UE 100-2) are a pair to communicate with each other via the base station without involving the core network. Second, the base station, in response to receiving the pairing information and the second identification information (e.g., the RAN identification information of the UE 100-2), configures the first data radio bearer.

This allows the gNB 200 to know that there is the pair performing the P2P communication. Then, the gNB 200 can configure the local routing described in the first embodiment for the pair.

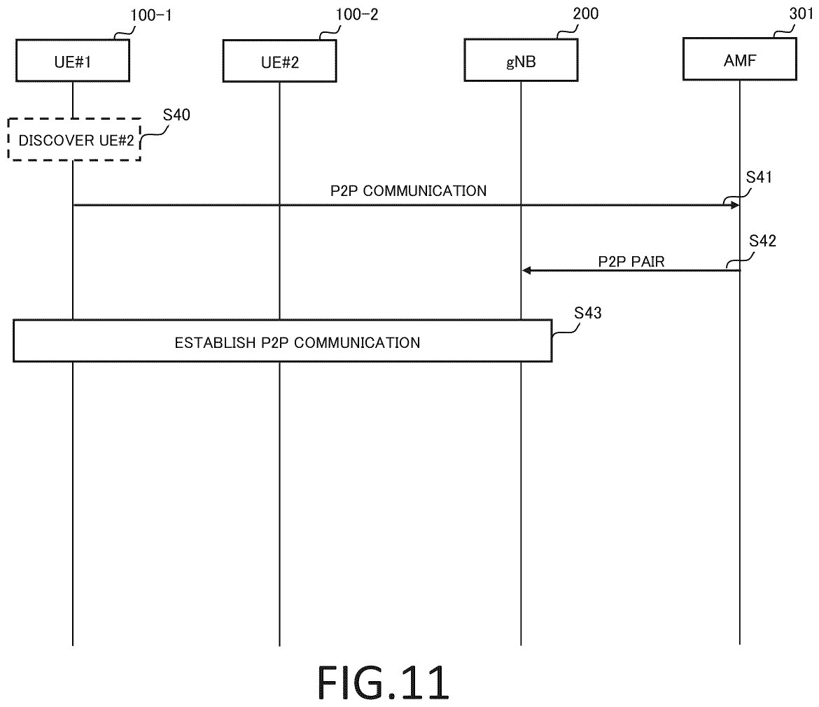

FIG. 11 is a diagram illustrating an operation example according to the third embodiment.

As illustrated in FIG. 11, in step S40, the UE 100-1 may use the discovery function to discover the UE 100-2. The discovery function may be a function using the Direct Discovery of ProSe communication or a function using Open Connectivity Foundation, as in the first embodiment. When the UE 100-1 discovers the UE 100-2, the UE 100-1 may determine to perform P2P communication with the UE 100-2.

In step S41, the UE 100-1 transmits information indicating that the P2P communication is performed with the UE 100-2 to the AMF 301. The UE 100-1 may transmit an NAS message including the information to transmit the information. The information may be the RAN identification information.

In step S42, the AMF 301 transmits the pairing information to the gNB 200. The pairing information is information indicating that the UE 100-1 and the UE 100-2 are a pair performing P2P communication via the gNB 200 without involving the core network. The AMF 301 may transmit an NAS message including the pairing information to transmit the pairing information. The information may be a request to establish a communication path for P2P communication. The pairing information may include the RAN identification information.

In step S43, the gNB 200, and the UEs 100-1 and 100-2 perform processing for establishing P2P communication. The processing for establishing P2P communication may be the process from step S10 to step S21 in the first embodiment. In this case, when the gNB 200 receives the RAN identification information of the UE 100-2 from the UE 100-1 and further receives the pairing information from the AMF 301, the gNB 200 may configure a DRB for local routing for the UE 100-1 (step S14). The processing for establishing P2P communication may be the process from step S30 to step S38 in the second embodiment. In this case, when the gNB 200 receives the response from the UE 100-2 (step S34) and further receives the pairing information from the AMF 301, the gNB 200 may configure a DRB for the local routing for the UE 100-1 (step S35).

### Fourth Embodiment

### A Fourth Embodiment is Described

The first to third embodiments describe the example in which the local rerouting is performed in the gNB 200. In this case, the data does not reach the UPF 302. Therefore, the cellular communication system 1 may not acquire the data amount (or communication amount) for each user. As such, in the fourth embodiment, the gNB 200 records a data amount of the data transferred through the local routing and transmits the recorded data amount to the core network.

To be specific, first, the base station (e.g., gNB 200) transfers data received from the first user equipment (e.g., UE 100-1) by using the data radio bearer to the second user equipment (e.g., UE 100-2) without transferring the data to the core network. Second, the base station transmits the data amount of the data to the core network (e.g., AMF 301).

This allows the core network to grasp the data amount of the data transferred through the local routing in the gNB 200, and adequately perform charging (or billing processing).

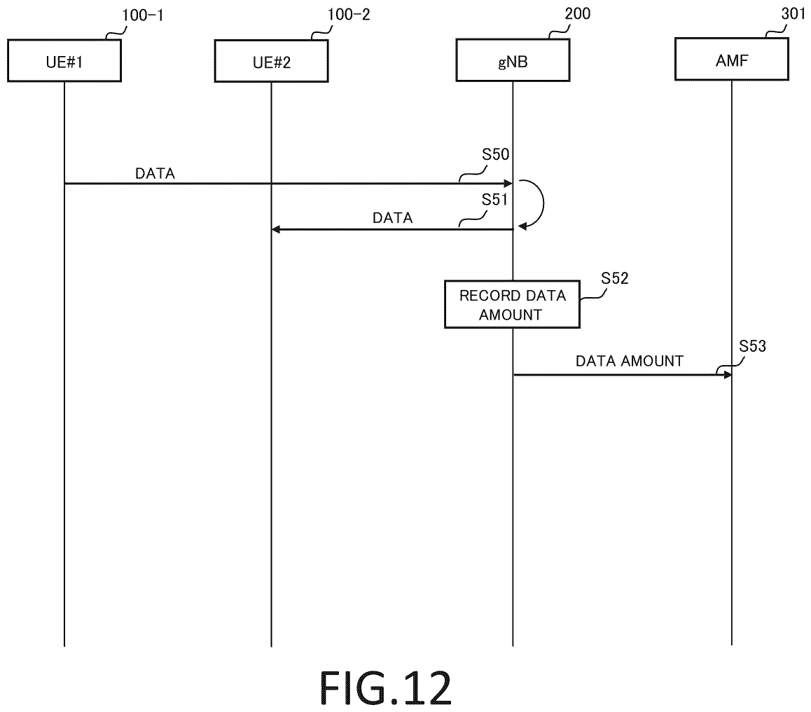

FIG. 12 is a diagram illustrating an operation example according to the fourth embodiment.

As illustrated in FIG. 12, in step S50, the UE 100-1 transmits data addressed to the UE 100-2 to the gNB 200.

In step S51, the gNB 200 transfers the data addressed to the UE 100-2 to the UE 100-2 through local routing without transferring the data to the core network.

In step S52, the gNB 200 records a data amount of the transferred data (step S51) in the memory. The gNB 200 may record a data amount of a payload part of the SDAP SDU. The gNB 200 may also record a data amount of a payload part of the PDCP SDU. The gNB 200 may record the data amount for each UE 100. The gNB 200 may record only a data amount of the data that is wirelessly communicated using a licensed band. In this case, charging is not performed for data wirelessly communicated using an unlicensed band.

In step S53, the gNB 200 transmits the recorded data amount to the core network. FIG. 12 illustrates an example of the AMF 301 as a core network.

### OTHER EMBODIMENTS

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing the processes to be performed by the UE 100 or the gNB 200 may be integrated, and at least part of the UE 100 or the gNB 200 may be configured as a semiconductor integrated circuit (a chipset or an SoC).

The phrases “based on” and “depending on” used in the present disclosure do not mean “based only on” and “only depending on”, unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Although embodiments have been described in detail with reference to the drawings, a specific configuration is not limited to those described above, and various design modifications and the like can be made without departing from the scope of the present disclosure. All of or a part of the embodiments can be combined together as long as no inconsistencies are introduced.

### REFERENCE SIGNS

1 Mobile communication system
10 5GC
100 (100-1 to 100-2) UE
110 Wireless communicator
120 Controller
200 (200-1 to 200-3) gNB
210 Wireless communicator
220 Network communicator
230 Controller
301 AMF
302 UPF

1. A communication control method comprising the steps of:
acquiring, by a first user equipment, second identification information to identify a second user equipment, and acquiring, by the second user equipment, first identification information to identify the first user equipment, the first user equipment and the second user equipment being in a state of discovery with each other;
transmitting, by the first user equipment, the second identification information to a communication apparatus, and transmitting, by the second user equipment, the first identification information to the communication apparatus;
configuring, by the communication apparatus, a first data radio bearer to the first user equipment in response to receiving the second identification information, and configuring, by the communication apparatus, a second data radio bearer to the second user equipment in response to receiving the first identification information; and
transferring, by the communication apparatus, first data received from the first user equipment by using the first data radio bearer to the second user equipment by using the second data radio bearer without transferring the first data to a core network.

2. The communication control method according to claim 1, wherein
the communication apparatus is a base station
the first user equipment is connected to the base station, and
the core network is connected to the base station.

3. The communication control method according to claim 1, wherein
the communication apparatus is a third user equipment.

4. The communication control method according to claim 1, wherein
the transferring includes transferring, by the communication apparatus, second data received from the second user equipment by using the second data radio bearer to the first user equipment by using the first data radio bearer without transferring the second data to the core network.

5. The communication control method according to claim 2, further comprising:
transmitting, by a core network apparatus connected to the core network, pairing information to the base station, the pairing information indicating that the first user equipment and the second user equipment are a pair performing communication with each other via the base station without via the core network, wherein
the configuring includes configuring, by the base station, the first data radio bearer in response to receiving the pairing information and the second identification information.

6. The communication control method according to claim 1, further comprising:
transmitting, by the base station, a data amount of the first data to the core network.

7. A base station communicable with a first user equipment and a second user equipment, the base station comprising:
a receiver circuitry configured to receive second identification information to identify the second user equipment from the first user equipment being in a state of discovery with the second user equipment each other and receive first identification information to identify the first user equipment from the second user equipment;
a processor circuitry configured to configure a first data radio bearer to the first user equipment in response to receiving the second identification information and configure a second data radio bearer to the second user equipment in response to receiving the first identification information; and
a transmitter circuitry configured to transfer first data received from the first user equipment by using the first data radio bearer to the second user equipment by second data radio bearer without transfer the first data to a core network.

8. A processor of a base station communicable with a first user equipment and a second user equipment, the processor comprising:
receiving second identification to identify a second user equipment from the first user equipment being in a state of discovery with the second user equipment each other and receiving first identification information to identify the first user equipment from the second user equipment:
configuring a first data radio bearer to the first user equipment in response to receiving the second identification information and configuring a second data radio bearer to the second user equipment in response to receiving the first identification information; and
transferring first data received from the first user equipment by using the first data radio bearer to the second user equipment by second data radio bearer without transferring the first data to a core network.
